(19) United States
(12) Patent Application Publication
(10) Pub. No.: US 2020/0042892 A1
(43) Pub. Date: Feb. 6, 2020

(54) INFORMATION PROCESSING DEVICE, INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Hiroki NAKAYAMA, Tokyo (JP); Takashi SHIRAKI, Tokyo (JP)

(73) Assignee: NEC Corporation, Minato-ku, Tokyo (JP)

(21) Appl. No.: 16/492,205

(22) PCT Filed: Mar. 29, 2017
(86) PCT No.: PCT/JP2017/012992

§ 371 Date: Sep. 9, 2019

(51) Int. Cl. G06N 7/00; G06N 5/02; G06N 20/00

(52) U.S. Cl. CPC G06N 7/005; G06N 20/00; G06N 5/022

(57) ABSTRACT

An information processing device according to the present invention includes: a memory; and at least one processor coupled to the memory. The processor performs operations. The operations includes: calculating, in a graph including a node and a link indicating a connection relationship between the nodes, a second probability of the node to be calculated, based on a first probability set for the link; extracting the link, when the second probabilities of the nodes being both ends of the link satisfies a predetermined condition; outputting first information relevant to the extracted link and the graph; acquiring second information relevant to the first information; and updating the first probability of the link in the graph, based on the second information.

### TECHNICAL FIELD

The present invention relates to information processing, and, in particular, relates to an information processing device and the like that process a graph representing an inter-event relationship.

### BACKGROUND ART

With advance of information processing technology, a technique of processing information such as knowledge is widely used (for example, see Patent Literatures (PTLs) 1 and 2).

PTL 1 discloses a technique of determining a path of a highest probability in a prediction model using a clustering technique, and predicting defect data on the basis of the determined path.

PTL 2 discloses a technique of acquiring, from a user, a condition relevant to knowledge and filtering and a constraint for display, and acquiring data that a user wants, on the basis of the acquired information.

One of techniques of processing knowledge is automated reasoning, in which events and a proposition relating to a relationship between the events are processed. In a field of automated reasoning, a directed graph used for inference (hereinafter, referred to as an “inference graph”) has an event as a node, and has a proposition being an inter-event relationship as a link. Note that the proposition is related to “knowledge”. In the following description, a proposition (a link) being a relationship between a certain event (event 1) and another event (event 2) is represented as “event 1→event 2”. Note that, when a proposition (link) has a hierarchical structure, the proposition (link) “event event 2” is not limited to a case in which event 1 and event 2 are directly connected, and may be a connection that includes another event and/or another proposition between the connected events 1 and 2. In other words, a link may include another event and/or another proposition.

Note that a node may be called a vertex. Further, a link may be called an edge (a branch) or an arc.

A probability such that a link is established (for example, a probability that event 2 is established after event 1 is established) is defined as a weight of the link (for example, see PTL 3).

In the inference graph, an achieved node (for example, an event detected by a sensor) is called an observation. Further, in the inference graph, a node to be inquired (for example, an event that a user wants to know) is called a query. For example, it is assumed that an inference graph includes “a buzzer sounded” and “a person intruded” as nodes. When it is estimated, by using this inference graph, that “a person intruded” when it is detected that “a buzzer sounded”, the node “a buzzer sounded” is an observation (an observation node) and the node “a person intruded” is a query (a query node).

An information processing device that processes an inference graph calculates, in the inference graph, a probability of a path being a set of links connecting between an observation and a query, on the basis of a probability of a link.

Then, the information processing device outputs a path of a highest probability or paths of probabilities within a predetermined range in descending order, as a result of inference. In this way, a probability of a path is used for selection of a path, and is one of indices indicating importance of a path.

Note that calculating a path of a high probability in an information processing device results in a shortest path problem in an inference graph. In other words, an information processing device is able to calculate an optimal path by solving the shortest path problem. The shortest path problem is described in, for example, Non Patent Literature (NPL) 1.

In addition, an information processing device that uses an inference graph updates a probability of a link included in the inference graph (for example, see PTL 3). The higher a probability of a link included in a path, the higher a probability of the path. In other words, a probability of a link is one of indices for importance of the link.

### CITATION LIST

### Patent Literature

[PTL 1] Japanese Unexamined Patent Application Publication No. 2016-038626
[PTL 2] Japanese Unexamined Patent Application Publication No. 2008-152739
[PTL 3] International Publication WO 2016/121054

### Non Patent Literature

[NPL 1] “Shortest Path Problem”, [Online], Wikipedia, [retrieved on Mar. 6, 2017], the Internet (URL:https://ja.wikipedia.org/wiki/%E6%9C%80%E7%9F%AD%E7%B5%8C%E8%B7%AF%E5%95%8F%E9%A1%8C)

### SUMMARY OF INVENTION

### Technical Problem

However, it is not always possible to acquire all pieces of information for updating a probability of a link. Thus, a case occurs in which a value of a probability of a link included in an inference graph is not appropriately updated. Then, when a probability of a link is smaller than a value that would be originally supposed to be, a probability of a path including the link is lower than an original value. As a consequence, an information processing device is unable to output a path (a path whose probability is originally high) including the link, as a result of inference. In this case, a user ends up failing to find a potential inference path (a path whose probability originally becomes high).

As a countermeasure therefor, a method of making an inquiry to a user about a degree (specifically, a probability of a link) of importance of a link included in an inference graph is conceivable.

However, a general inference graph includes an enormous number of links. Thus, making an inquiry to a user about probabilities of all links is substantially infeasible, or requires a great deal of time.

In view of the above, making an inquiry after selecting a link of a low probability, in order to reduce the number of links to be inquired, is conceivable.

However, an inference graph includes a large number of nodes. Then, most of the nodes have a low relationship with one another. Thus, most of links included in the inference graph are links whose probability is close to nearly zero, because of a low relationship. As described above, most of links among links of a low probability are not important for inference. In other words, most of links of a low probability are links about which no inquiry needs to be made to a user.

Thus, in updating of a probability of a link included in an inference graph, it is desired to select a link suitable for making an inquiry to a user.

However, PTLs 1 to 3 and NPL 1 do not disclose any technique of selecting an appropriate link for making an inquiry to a user, in connection with updating of an inference graph. In other words, the techniques described in PTLs 1 to 3 and NPL 1 have issues that a probability of a link cannot be appropriately updated in updating of an inference graph.

An object of the present invention is to solve the above-described issue and provide an information processing device and the like that appropriately update a probability of a link in updating of an inference graph.

### Solution to Problem

An information processing device according to one aspect of the present invention includes:

probability calculation means for calculating, in a graph including a node and a link indicating a connection relationship between the nodes, a second probability of the node to be calculated, based on a first probability set for the link;

link extraction means for extracting the link, when the second probabilities of the nodes being both ends of the link satisfies a predetermined condition;

link output means for outputting first information relevant to the extracted link and the graph;

update-information acquisition means for acquiring second information relevant to the first information; and

inference updating means for updating the first probability of the link in the graph, based on the second information.

An information processing method according to one aspect of the present invention includes:

calculating, in a graph including a node and a link indicating a connection relationship between the nodes, a second probability of the node to be calculated, based on a first probability set for the link;

extracting the link, when the second probabilities of the nodes being both ends of the link satisfies a predetermined condition;

outputting first information relevant to the extracted link and the graph;

acquiring second information relevant to the first information; and

updating the first probability of the link in the graph, based on the second information.

A recording medium according to one aspect of the present invention records, in a computer-readable way, a program causing a computer to execute:

a process of calculating, in a graph including a node and a link indicating a connection relationship between the nodes, a second probability of the node to be calculated, based on a first probability set for the link;

a process of extracting the link, when the second probabilities of the nodes being both ends of the link satisfies a predetermined condition;

a process of outputting first information relevant to the extracted link and the graph;

a process of acquiring second information relevant to the first information; and

a process of updating the first probability of the link in the graph, based on the second information.

An information processing system according to one aspect of the present invention includes:

the above-mentioned information processing device;

a display device that acquires the first information from the information processing device, and displays the first information; and

an input device that acquires the second information, and transmits the second information to the information processing device.

An information processing system according to one aspect of the present invention includes:

the above-mentioned information processing device; and

an inference device that transmits the graph to the information processing device, receives the updated graph from the information processing device, and executes inference by using the updated graph.

### Advantageous Effects of Invention

According to the present invention, an advantageous effect of appropriately updating a probability of a link in updating of an inference graph can be exhibited.

### BRIEF DESCRIPTION OF DRAWINGS

FIG. 1 is a block diagram illustrating one example of a configuration of an information processing device according to a first example embodiment of the present invention.

FIG. 2 is a block diagram illustrating one example of an information processing system including the information processing device according to the first example embodiment.

FIG. 3 is a flowchart illustrating one example of an operation of the information processing device according to the first example embodiment.

FIG. 4 is a flowchart illustrating one example of an operation in a probability calculation unit according to the first example embodiment.

FIG. 5 is a block diagram illustrating one example of a hardware configuration of the information processing device according to the first example embodiment.

FIG. 6 is a diagram illustrating an inference graph for use in description.

FIG. 7 is a diagram illustrating one example of nodes in the inference graph in FIG. 6.

FIG. 8 is a diagram illustrating probabilities of links in the inference graph in FIG. 6.

FIG. 9 is a diagram illustrating an initial state of forward-direction scores according to the first example embodiment.

FIG. 10 is a diagram illustrating a next state of FIG. 9.

FIG. 11 is a diagram illustrating a next state of FIG. 10.

FIG. 12 is a diagram illustrating a next state of FIG. 11.

FIG. 13 is a diagram illustrating a next state of FIG. 12.

FIG. 14 is a diagram illustrating a next state of FIG. 13.

FIG. 15 is a diagram illustrating a next state of FIG. 14.

FIG. 16 is a diagram illustrating a next state of FIG. 15.

FIG. 17 is a diagram illustrating an initial state of backward-direction scores according to the first example embodiment.

FIG. 18 is a diagram illustrating a next state of FIG. 17.

FIG. 19 is a diagram illustrating a next state of FIG. 18.

FIG. 20 is a diagram illustrating a next state of FIG. 19.

FIG. 21 is a diagram illustrating a next state of FIG. 20.

FIG. 22 is a diagram illustrating a next state of FIG. 21.

FIG. 23 is a diagram illustrating a next state of FIG. 22.

FIG. 24 is a diagram illustrating a next state of FIG. 23.

FIG. 25 is a diagram illustrating one example of forward-direction scores and backward-direction scores.

FIG. 26 is a diagram illustrating evaluation values for links.

FIG. 27 is a diagram illustrating one example of probabilities of links after updating.

FIG. 28 is a block diagram illustrating one example of a second information processing system including the information processing device.

### EXAMPLE EMBODIMENT

Next, example embodiments of the present invention will be described with reference to the drawings.

Note that the drawings are intended for describing the example embodiments of the present invention. However, the present invention is not limited to the description of the drawings. Further, similar components are assigned similar numerals throughout the drawings, and repeated description therefor may be omitted. Further, in the drawings used in the following description, description of a component in a part unrelated to the description of the present invention may be omitted, and the component may not be illustrated. Further, a direction of an arrow in the drawings indicates one example, and is not intended to limit a direction of a signal between blocks.

### First Example Embodiment

A first example embodiment will be described below with reference to the drawings.

[Description of Configuration]

First, an information processing system 10, which is one example of a system including an information processing device 20, will be described with reference to the drawings.

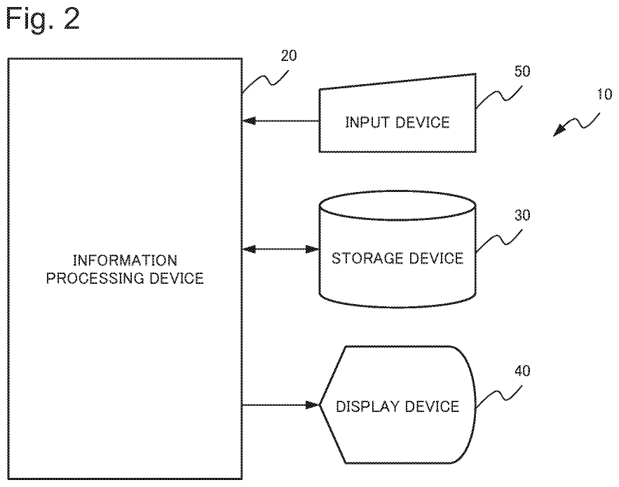

FIG. 2 is a block diagram illustrating one example of a configuration of the information processing system 10 including the information processing device 20 according to the first example embodiment of the present invention.

The information processing system 10 includes an input device 50, the information processing device 20, a storage device 30, and a display device 40.

The input device 50 acquires information needed by the information processing device 20 for processing, and transmits the acquired information to the information processing device 20. For example, the input device 50 includes a keyboard, detects an input operation of a user, and transmits an input result to the information processing device 20.

The storage device 30 stores an inference graph (hereinafter, simply referred to also as a “graph”) used by the information processing device 20. For example, the storage device 30 is a hard disk device, a magneto-optical disk device, a solid state drive (SSD), or a disk array device. The storage device 30 may be constructed as a database.

The display device 40 displays an output of the information processing device 20. For example, the display device 40 is a liquid crystal display.

Note that the input device 50 and the display device 40 do not need to be separate devices, and may be one device. For example, the input device 50 and the display device 40 may be a touch panel including a touch pad and a liquid crystal display. In addition, the input device 50, the display device 40, and the storage device 30 may be one device. For example, the input device 50, the display device 40, and the storage device 30 may be a tablet type computer including a touch panel.

As will be described later in detail, the information processing device 20 acquires necessary information from the input device 50, and outputs, to the display device 40, information relevant to a link satisfying a predetermined condition, by using an inference graph stored in the storage device 30. The display device 40 displays the information relating to the link. The input device 50 acquires update-information related to the information relating to the link, and transmits the acquired update-information to the information processing device 20. The information processing device 20 acquires, from the input device 50, the update-information related to the information displayed on the display device 40, updates the inference graph as needed, and stores the updated inference graph in the storage device 30.

Next, a configuration of the information processing device 20 will be described with reference to the drawings.

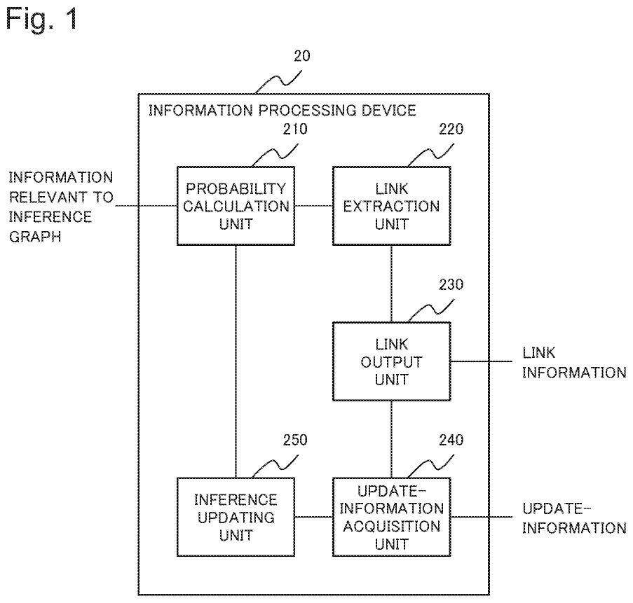

FIG. 1 is a block diagram illustrating one example of the configuration of the information processing device 20 according to the first example embodiment of the present invention. The information processing device 20 includes a probability calculation unit 210, a link extraction unit 220, a link output unit 230, an update-information acquisition unit 240, and an inference updating unit 250.

The probability calculation unit 210 acquires information relevant to an inference graph being a processing target of the information processing device 20. The probability calculation unit 210 may acquire any information relevant to an inference graph. For example, the probability calculation unit 210 may acquire an inference graph including an observation, a query, and a probability of a link. In this case, for example, the probability calculation unit 210 may acquire an inference graph to be a processing target, an observation, and a query from the input device 50 illustrated in FIG. 1. Alternatively, the probability calculation unit 210 may acquire nodes (events) and a link (a connection relationship between the nodes and a probability thereof) being a relationship between nodes from the input device 50, and may generate an inference graph to be a processing target.

Further, the probability calculation unit 210 may acquire information relevant to an inference graph from any acquisition source. For example, the probability calculation unit 210 may acquire information recorded in the storage device 30 rather than from the input device 50. In this case, a user may store information in the storage device 30 in advance by using the input device 50. Alternatively, the probability calculation unit 210 may acquire an inference graph from a not-illustrated external device.

The probability calculation unit 210 may store an acquired or generated inference graph in a predetermined device (for example, the storage device 30 in FIG. 1).

Then, the probability calculation unit 210 calculates, for each node, a probability of a path including the nodes, by using a probability set for a link in an inference graph (hereinafter, referred to as a “link probability” or a “first probability”). Herein, a probability of a path is a maximum value of a product of link probabilities of links included in a path connecting between a node at a start point of the path and a node at an end point of the path.

More specifically, the probability calculation unit 210 calculates, in each node, a probability of a path with the node as an end point and a node related to an observation (an observation node) as a start point. In addition, the probability calculation unit 210 calculates a probability of a path with the node as a start point and a node related to a query (a query node) as an end point. Hereinafter, a probability calculated as described above will be referred to as a “node probability” or a “second probability”.

In other words, the probability calculation unit 210 calculates, as node probabilities, two node probabilities in the following way. The probability calculation unit 210 calculates, by tracing nodes along a forward direction being a direction from an observation node toward a query node in an inference graph, a probability of a path from the observation node to each node. Hereinafter, a node probability calculated by the probability calculation unit 210 along a forward direction of an inference graph will be referred to as a “first node probability” or a “third probability”. In addition, the probability calculation unit 210 calculates, by tracing nodes along a backward direction being a direction from a query node toward an observation node in an inference graph, a probability of a path from each node to the query node. Hereinafter, a node probability calculated by the probability calculation unit 210 along a backward direction of an inference graph will be referred to as a “second node probability” or a “fourth probability”.

However, a first node probability and a second node probability may be calculated in any order. The probability calculation unit 210 may first calculate a first node probability, or may first calculate a second node probability. In addition, the probability calculation unit 210 may calculate a first node probability and a second node probability in parallel.

The link extraction unit 220 extracts, in each link, a link to be output to a user and the like, by using node probabilities of nodes being both ends of a link. More specifically, the link extraction unit 220 extracts a link for which node probabilities of nodes at both ends of the link satisfy a predetermined condition. A condition in this case is a condition to extract a link for which a probability of a path including the link is very likely to become high when a probability set for the link is increased.

For extraction of a link satisfying such a condition, the link extraction unit 220 uses an evaluation function giving a node probability as a variable. As one example of the evaluation function, the following description uses an evaluation function indicated as Equation 1. Note that p(AB) indicates a probability of a path from node A to node B. For example, p(observation→start point of link) is a probability of a path from an observation node to a node being at a start point of a target link. This probability is a node probability that the probability calculation unit 210 calculates in the above. For example, when a node at a start point of a link is denoted by node A, p(observation→node A) is a first node probability (a forward-direction node probability) of node A. Further, p(node A→query) is a second node probability (a backward-direction node probability) of node A.

Evaluation function(link)=p(observation→start point of link)×p(end point of link→query)−max(p(observation→start point of link)×p(start point of link→query),p(observation→end point of link)×p(end point of link→query)) [Equation 1]

In the above evaluation function, max is a function that selects a largest value among values within the parenthesis. A first term on a right side of Equation 1 is a probability of a path from an observation to a query in a case of excluding the link. A second term is a maximum probability of a path from an observation to a query in a case of including the link. In other words, the evaluation function is a change in a probability of a path including the link between the case of excluding the link and the case of including the link. In other words, the evaluation function is a function that gives a higher value when a condition that “a probability of a path (an inference path) including the link becomes high when a probability of the link is increased (allowing a proposition related to the link to hold)” is easily satisfied.

The link extraction unit 220 extracts a link having a value of the evaluation function satisfying a predetermined condition. For example, the link extraction unit 220 extracts a link having a highest value of the evaluation function. Alternatively, the link extraction unit 220 may extract a predetermined number of links in descending order of values of the evaluation function. Alternatively, the link extraction unit 220 may extract a link having a value of the evaluation function larger than a predetermined threshold value.

The link output unit 230 outputs information (hereinafter, referred to as “link information” or “first information”) relevant to a link extracted by the link extraction unit 220. For example, the link output unit 230 outputs link information to the display device 40 illustrated in FIG. 2.

Note that link information to be output may be determined according to update-information to be described later. For example, the link information is information (for example, a number, a name, or the like of a link) indicating a link, a probability of the link, and information (for example, names of a node and a link included in an inference path) indicating an inference path including the link. Alternatively, for example, the link information is information for displaying the link on the display device 40. One example of the link information in the case includes information as follows.

(1) Information on an inference graph
(2) Information on a path including a link in an inference graph
(3) Information on an observation and a query in an inference graph
(4) Information on a link in an inference graph
(5) A probability of a link
The display device 40 may display, on the basis of these pieces of information, information for acquiring update-information to be described later.

The update-information acquisition unit 240 acquires information relevant to link information (hereinafter, “update-information” or “second information”) output by the link output unit 230. The update-information is information relevant to updating of a probability of an extracted link. For example, the update-information acquisition unit 240 acquires, as the update-information, a result of determination made by a user on an output of the link output unit 230 displayed by the display device 40, from the input device 50.

More specifically, for example, the update-information is information indicating whether or not to update a probability with respect to a link. Alternatively, the update-information is an updated probability with respect to a link. For example, the update-information acquisition unit 240 may acquire an updated value of a probability of a link from the input device 50.

Alternatively, the update-information acquisition unit 240 may operate as follows. After the link output unit 230 outputs link information, the update-information acquisition unit 240 causes the display device 40 to display an inquiry as to whether or not to update a probability. Then, when acquiring an instruction to update a probability from the input device 50, the update-information acquisition unit 240 causes the display device 40 to display asking to input a probability to be updated. Then, the update-information acquisition unit 240 acquires, from the input device 50, a probability to be updated. Then, the update-information acquisition unit 240 transmits the acquired probability to the inference updating unit 250. When acquiring an instruction not to update a probability from the input device 50, the update-information acquisition unit 240 ends the processing.

The inference updating unit 250 updates a link probability set for a link in an inference graph, on the basis of update-information (for example, an updated probability of a link) acquired by the update-information acquisition unit 240.

In this way, the information processing device 20 is able to update a link probability in an inference graph.

Note that the information processing device 20 may output an updated inference graph. For example, the inference updating unit 250 may transmit an updated inference graph to the display device 40 via the link output unit 230. In this case, the display device 40 displays the received updated inference graph. A user is able to check the updated inference graph on the basis of this display.

In addition, the information processing device 20 may repeat a similar operation by using an updated inference graph. For example, the information processing device 20 may repeat the following operation until the update-information acquisition unit 240 acquires update-information indicating not to perform updating.

The probability calculation unit 210 re-calculates a node probability (a second probability) by using an inference graph in which a link probability (a first probability) is updated. The link extraction unit 220 re-extracts a link on the basis of the re-calculated node probabilities (second probabilities). The link output unit 230 re-outputs link information (first information) relevant to the re-extracted link. The update-information acquisition unit 240 re-acquires update-information (second information) relevant to the re-output link information (first information). The inference updating unit 250 re-updates the link probability (first probability) in the inference graph on the basis of the re-acquired update-information (second information).

In the case of the above-described operation, the display device 40 executes display on the basis of the re-output link information. Then, when a probability of a link is appropriately updated in a previous operation, the re-output link information does not include a previously updated link. Meanwhile, when a probability of a link is not appropriately updated in a previous operation, the re-output link information includes a previously updated link. Thus, a user is able to check whether or not a probability of a link is appropriately updated, on the basis of new display on the display device 40.

[Description of Operation]

Next, an operation of the information processing device 20 according to the first example embodiment will be described with reference to the drawings.

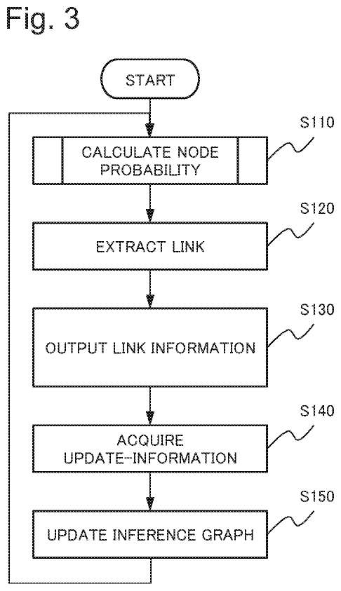

FIG. 3 is a flowchart illustrating one example of the operation of the information processing device 20 according to the first example embodiment.

The probability calculation unit 210 acquires information relevant to an inference graph. Then, the probability calculation unit 210 calculates node probabilities (a first node probability and a second node probability) (Step S110). For example, the probability calculation unit 210 acquires information relevant to an inference graph from the input device 50 or the storage device 30, and calculates node probabilities.

This operation will be described in detail with reference to the drawing.

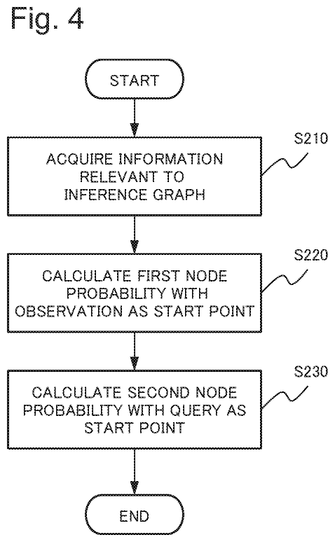

FIG. 4 is a flowchart illustrating one example of an operation of the probability calculation unit 210 according to the first example embodiment.

The probability calculation unit 210 acquires information relevant to an inference graph (Step S210).

The probability calculation unit 210 calculates, in the inference graph, a node probability (a first node probability) in a forward direction being a direction toward an end point (a query) with an observation as a start point (Step S220).

In addition, the probability calculation unit 210 calculates, in the inference graph, a node probability (a second node probability) in a backward direction being a direction toward a start point (an observation) with a query as an end point (Step S230).

In this way, the probability calculation unit 210 calculates two node probabilities for each node.

Return to the description with reference to FIG. 3.

The link extraction unit 220 extracts, on the basis of the calculated node probabilities, a link for which node probabilities of nodes at both ends satisfy a predetermined condition (Step S120).

The link output unit 230 outputs information (link information) relevant to the extracted link and the inference graph (Step S130). For example, the link output unit 230 outputs link information to the display device 40.

The update-information acquisition unit 240 acquires update-information (Step S140). For example, the update-information acquisition unit 240 acquires update-information from the input device 50.

The inference updating unit 250 updates the inference graph on the basis of the update-information (Step S150). Specifically, the inference updating unit 250 updates a probability of a link determined to be updated.

[Description of Advantageous Effects]

As described above, the information processing device 20 according to the first example embodiment can exhibit an advantageous effect of appropriately updating a probability of a link in updating of an inference graph.

The reason is as follows.

The probability calculation unit 210 calculates, in a graph including nodes and an inference link indicating a connection relationship between nodes, a node probability (a second probability) of the node to be calculated on the basis of a link probability (a first probability) set for the link. The link extraction unit 220 extracts the link, when the node probabilities (second probabilities) of the nodes being both ends of the link satisfy a predetermined condition. The link output unit 230 outputs link information (first information) relevant to the extracted link and the graph. The update-information acquisition unit 240 acquires update-information (second information) relevant to the link information (first information). The inference updating unit 250 updates the link probability (first probability) of the link in the graph on the basis of the update-information (second information).

Herein, the link extraction unit 220 extracts, on the basis of node probabilities at both ends of a link, a link for which a probability of a path including the link is highly likely to become high when a probability of the link is increased. Then, the link output unit 230 outputs information relevant to the link. In other words, the link output unit 230 outputs information relevant to an appropriate link for making an inquiry to a user. Thus, the update-information acquisition unit 240 acquires update-information relevant to the appropriate link. As a consequence, the inference updating unit 250 is able to appropriately update a probability of a link.

In addition, the probability calculation unit 210 calculates two node probabilities as node probabilities. The calculation includes calculations regarding two directions, a forward direction and a backward direction in an inference graph, and does not include any complicated calculation such as going back and forth through links in the inference graph. Thus, the calculation performed by the probability calculation unit 210 is a low-load calculation in comparison with general optimization calculation including complicated calculation.

[Hardware Configuration]

Next, a hardware configuration of the information processing device 20 will be described.

The information processing device 20 described in the above is configured as follows.

For example, the components of the information processing device 20 may be configured by a hardware circuit. Further, in the information processing device 20, the components may be configured by using a plurality of devices connected via a network. Further, in the information processing device 20, a plurality of components may be configured by one piece of hardware.

In addition, the information processing device 20 may include some or all of the input device 50, the display device 40, and the storage device 30.

Further, the information processing device 20 may be implemented as a computer device that includes a central processing unit (CPU), a read only memory (ROM), and a random access memory (RAM). The information processing device 20 may be implemented as a computer device that further includes an input and output circuit (IOC) in addition to the above configurations. In addition, the information processing device 20 may be implemented as a computer device that includes a network interface circuit (NIC).

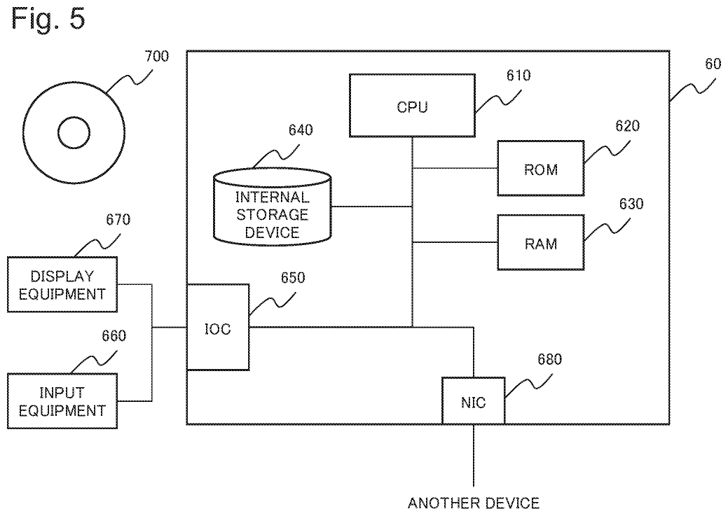

FIG. 5 is a block diagram illustrating a configuration of an information processing device 60, which is one example of the hardware configuration of the information processing device 20.

The information processing device 60 includes a CPU 610, a ROM 620, a RAM 630, an internal storage device 640, an IOC 650, and an NIC 680, and constitutes a computer device.

The CPU 610 reads a program from the ROM 620. Then, the CPU 610 controls the RAM 630, the internal storage device 640, the IOC 650, and the NIC 680 on the basis of the read program. Then, a computer including the CPU 610 controls these configurations, and implements the functions as the probability calculation unit 210, the link extraction unit 220, the link output unit 230, the update-information acquisition unit 240, and the inference updating unit 250 illustrated in FIG. 1.

When implementing the functions, the CPU 610 may use the RAM 630 or the internal storage device 640 as a temporary storage medium for a program.

Further, the CPU 610 may read a program included in a storage medium 700 on which a program is stored in a computer-readable way, by using a not-illustrated storage-medium reading device. Alternatively, the CPU 610 may receive a program from a not-illustrated external device via the NIC 680, store the received program in the RAM 630, and operate on the basis of the stored program.

The ROM 620 stores a program and fixed data to be executed by the CPU 610. The ROM 620 is, for example, a programmable-ROM (P-ROM) or a flash ROM.

The RAM 630 temporarily stores a program and data to be executed by the CPU 610. The RAM 630 is, for example, a dynamic-RAM (D-RAM).

The internal storage device 640 stores data and a program to be stored by the information processing device 60 for a long term. Further, the internal storage device 640 may operate as a temporary storage device for the CPU 610. The internal storage device 640 may operate as the storage device 30. The internal storage device 640 is, for example, a hard disk device, a magneto-optical disk device, an SSD, or a disk array device.

Herein, the ROM 620 and the internal storage device 640 are non-transitory storage media. Meanwhile, the RAM 630 is a transitory storage medium. Then, the CPU 610 is capable of operating on the basis of a program stored in the ROM 620, the internal storage device 640, or the RAM 630. In other words, the CPU 610 is capable of operating by using a non-transitory storage medium or a transitory storage medium.

The IOC 650 mediates data between the CPU 610 and an input equipment 660 and between the CPU 610 and a display equipment 670. The IOC 650 is, for example, an IO interface card or a universal serial bus (USB) card. In addition, the IOC 650 is not limited to be wired such as a USB, and may use a wireless.

The input equipment 660 is equipment that receives an input instruction from an operator of the information processing device 60. The input equipment 660 may operate as the input device 50. The input equipment 660 is, for example, a keyboard, a mouse, or a touch panel.

The display equipment 670 is equipment that displays information to an operator of the information processing device 60. The display equipment 670 may operate as the display device 40. The display equipment 670 is, for example, a liquid crystal display.

The NIC 680 relays data exchange with a not-illustrated external device via a network. The NIC 680 may mediate information with the input device 50, the storage device 30, and/or the display device 40. The NIC 680 is, for example, a local area network (LAN) card or a peripheral component interconnect (PCI) bus card. In addition, the NIC 680 is not limited to be wired, and may use a wireless.

The information processing device 60 configured as described above can achieve an advantageous effect similar to the information processing device 20. The reason is that the CPU 610 of the information processing device 60 is able to implement functions similar to those of the information processing device 20 on the basis of a program.

### Detailed Example

Next, a detailed example and the like of calculation of a node probability and calculation of an evaluation function according to the first example embodiment will be described with reference to the drawings.

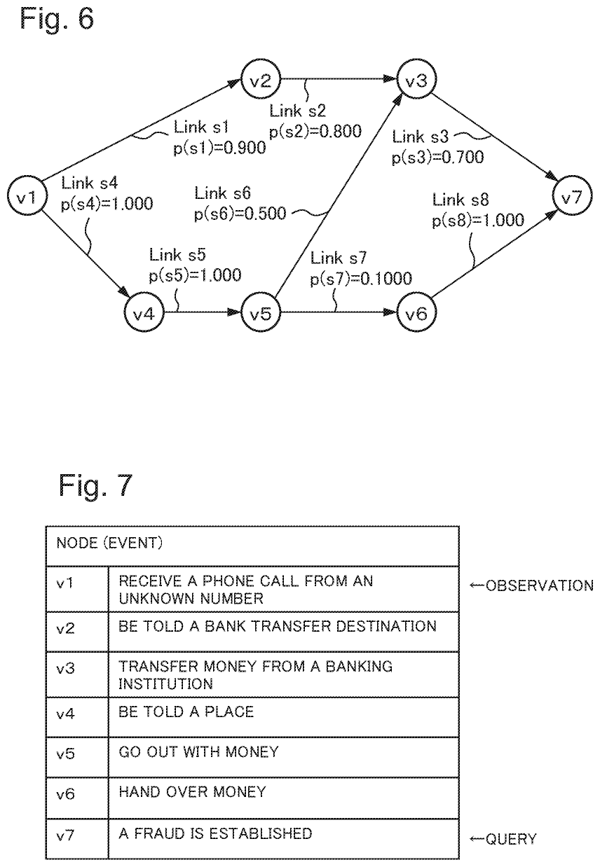

FIG. 6 is a diagram illustrating an inference graph for use in the following description. In FIG. 6, v1 to v7 are nodes. Arrows (s1 to s8) between the nodes are links. Probabilities (p(s1) to p(s8)) are respectively set for the links.

FIG. 7 is a diagram illustrating one example of nodes in the inference graph in FIG. 6. The nodes (events) illustrated in FIG. 7 are nodes (events) relevant to a special fraud. It is assumed that an observation is node v1: “Receive a phone call from an unknown person”. Further, it is assumed that a query is node v7: “A fraud is established”. In other words, inference in this case is estimation relating to a path connecting between the observation (Receive a phone call from an unknown person) and the query (A fraud is established).

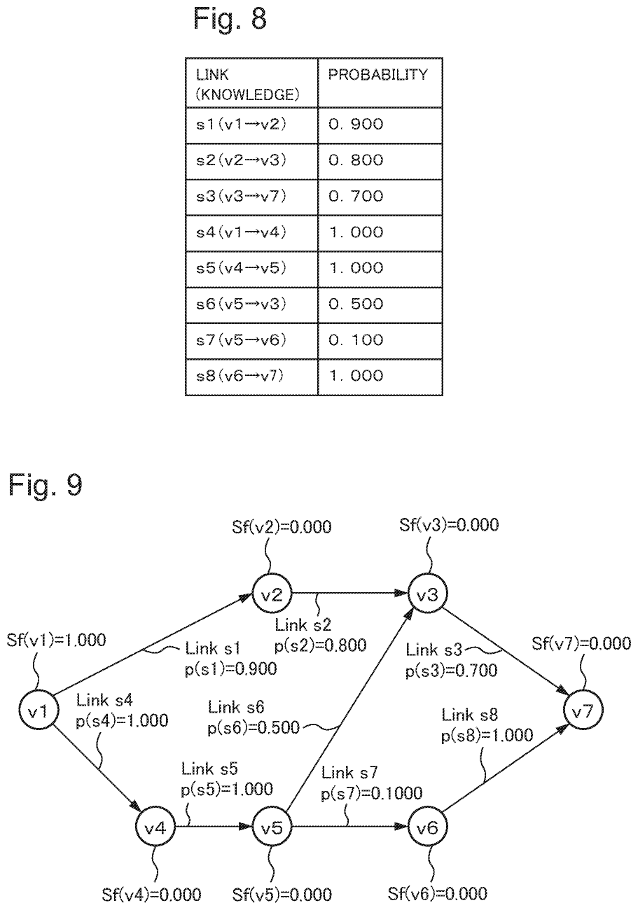

FIG. 8 is a diagram illustrating probabilities of links in the inference graph in FIG. 6. Note that, for a certain node (event), as links (propositions) occurring from the node, a plurality of links may occur concurrently, or none of the links may occur. For example, when node v1 (Receive a phone call from an unknown number) occurs, a link to node v2 (Be told a bank transfer destination) and a link to node v4 (Be told a place) may occur concurrently. Thus, a total probability of links exiting from a node is not limited to 1, and may exceed 1 or may be less than 1.

Note that, for facilitating distinction from a link probability, a node probability will be referred to as a “score” in the following description. Further, for facilitating comparison of numerical values, a value of a probability will be indicated to the third decimal place in the following description.

(Calculation in Forward-Direction)

The probability calculation unit 210 executes calculation as follows, as calculation of a forward-direction score (a first score).

(1) The probability calculation unit 210 sets, as initial values, a score of an observation node to “1.000” and scores of all other nodes to “0.000”. In addition, the probability calculation unit 210 sets all nodes as unprocessed.
(2) The probability calculation unit 210 repeats the following operations of (3) and (4) until there is no unprocessed node.
(3) The probability calculation unit 210 selects one node having a score of a highest value from among unprocessed nodes. Then, the probability calculation unit 210 sets a score of another node, which is ahead of all links exiting from the selected node in a forward direction, to a higher one of the following two values. In other words, the probability calculation unit 210 updates a score when a second value (a score in the case of passing through a link in a forward direction from the node) is higher than a first value (a current score).
[First value] A current score of another node
[Second value] (A score of the node)×(a probability of a link from the node to another node)
(4) The probability calculation unit 210 sets the node as processed.

A process of this calculation will be described below with reference to the drawings.

FIG. 9 is a diagram illustrating an initial state of forward-direction scores according to the first example embodiment.

As illustrated in FIG. 9, the probability calculation unit 210 sets a score of node v1 being an observation to “1.000” and scores of other nodes to “0.000”. Note that, in the following description, “Sf(⋅)” will be used as a function indicating a first score (a forward-direction score) of a node.

In FIG. 9, a node having a highest score among unprocessed nodes is node v1.

In view of the above, the probability calculation unit 210 selects node v1 (that is an observation node), which is a node having a score of a highest value.

Then, the probability calculation unit 210 sets scores of nodes (nodes v2 and v4), which are ahead of links (links s1 and s4) exiting from node v1. For example, a score of node v2 is “0.000” (see FIG. 9). Further, “a score of node v1×a probability of link s1” is “1.000×0.900=0.900”. Thus, the probability calculation unit 210 updates score Sf(v2) of node v2 to “0.900”. Similarly, the probability calculation unit 210 updates score Sf(v4) of node v4 to “1.000”.

Then, the probability calculation unit 210 sets node v1 as processed.

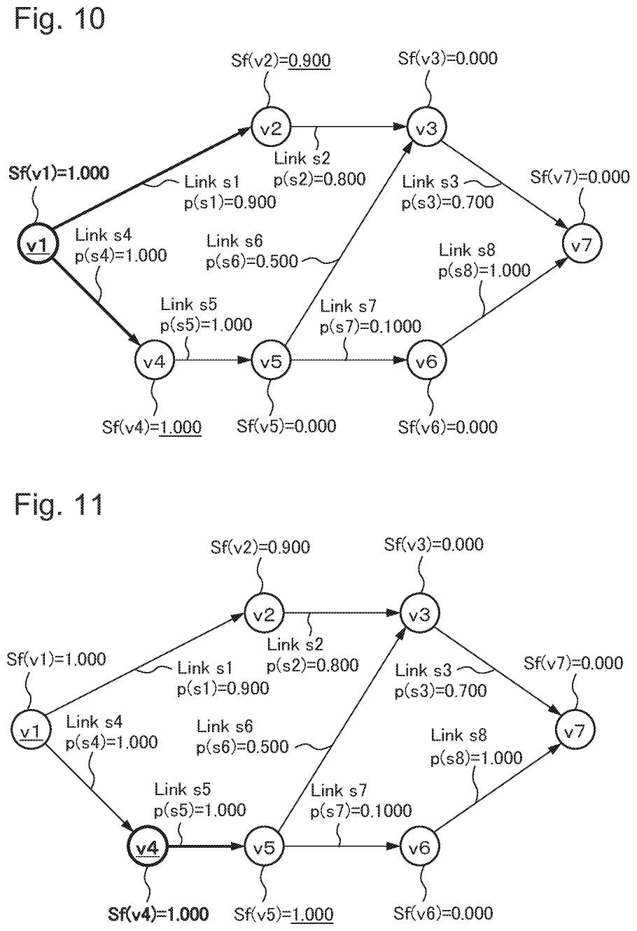

FIG. 10 is a diagram illustrating a next state of FIG. 9, which is the operation described above. In the following description, a node selected as a processing target will be denoted in bold. Further, an updated score will be underlined. Further, a processed node will be underlined.

For example, in FIG. 10, the probability calculation unit 210 selects node v1 as a processing target. Thus, a frame of node v1 is denoted in bold.

Further, scores (Sf(v2) and Sf(v4)) of nodes v2 and v4 are underlined since those scores are updated. Then, node v1 is underlined since the probability calculation unit 210 sets node v1 as processed.

In FIG. 10, there remain unprocessed nodes. In addition, in FIG. 10, a highest score among the unprocessed nodes is node v4. In view of this, the probability calculation unit 210 selects node v4 as a processing target, and executes similar processing.

FIG. 11 is a diagram illustrating a next state of FIG. 10. As illustrated in FIG. 11, the probability calculation unit 210 updates score Sf(v5) of node v5, which is ahead of link s5 exiting from node v4, to “1.000”.

In FIG. 11, there remain unprocessed nodes. In addition, in FIG. 11, a highest score among the unprocessed nodes is node v5. In view of this, the probability calculation unit 210 selects node v5 as a processing target, and executes similar processing.

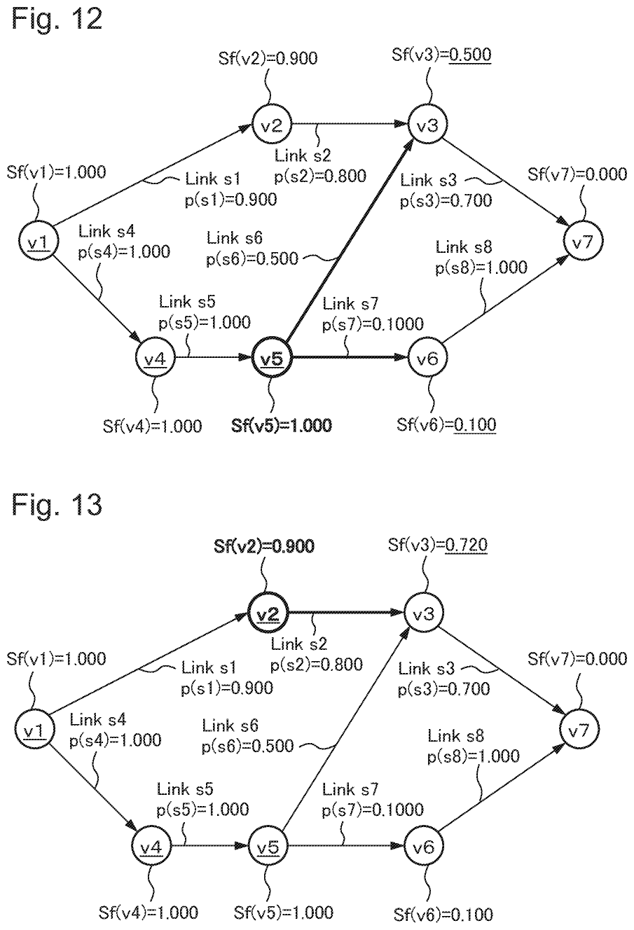

FIG. 12 is a diagram illustrating a next state of FIG. 11. As illustrated in FIG. 12, the probability calculation unit 210 updates scores (Sf(v3) and Sf(v6) of nodes v3 and v6.

In FIG. 12, there remain unprocessed nodes. In addition, in FIG. 12, a highest score among the unprocessed nodes is node v2. In view of this, the probability calculation unit 210 selects node v2 as a processing target, and executes similar processing.

FIG. 13 is a diagram illustrating a next state of FIG. 12. As illustrated in FIG. 13, the probability calculation unit 210 updates score Sf(v3) of node v3.

In FIG. 13, there remain unprocessed nodes. In addition, in FIG. 13, a highest score among the unprocessed nodes is node v3. In view of this, the probability calculation unit 210 selects node v3 as a processing target, and executes similar processing.

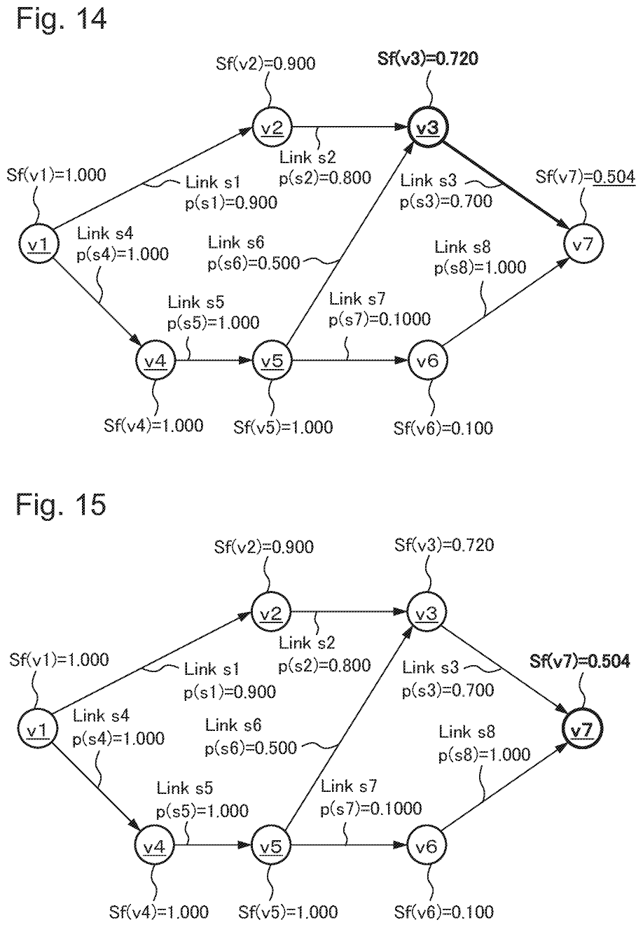

FIG. 14 is a diagram illustrating a next state of FIG. 13. As illustrated in FIG. 14, the probability calculation unit 210 updates score Sf(v7) of node v7.

In FIG. 14, there remain unprocessed nodes. In addition, in FIG. 14, a highest score among the unprocessed nodes is node v7. In view of this, the probability calculation unit 210 selects node v7 as a processing target, and executes similar processing.

FIG. 15 is a diagram illustrating a next state of FIG. 14. However, node v7 is a query. In other words, there is no forward-direction link output from node v7. Thus, the probability calculation unit 210 sets node v7 as processed, without calculating a score.

In FIG. 15, there remains an unprocessed node. In addition, in FIG. 15, a highest score among the unprocessed nodes is node v6. In view of this, the probability calculation unit 210 selects node v6 as a processing target, and executes similar processing.

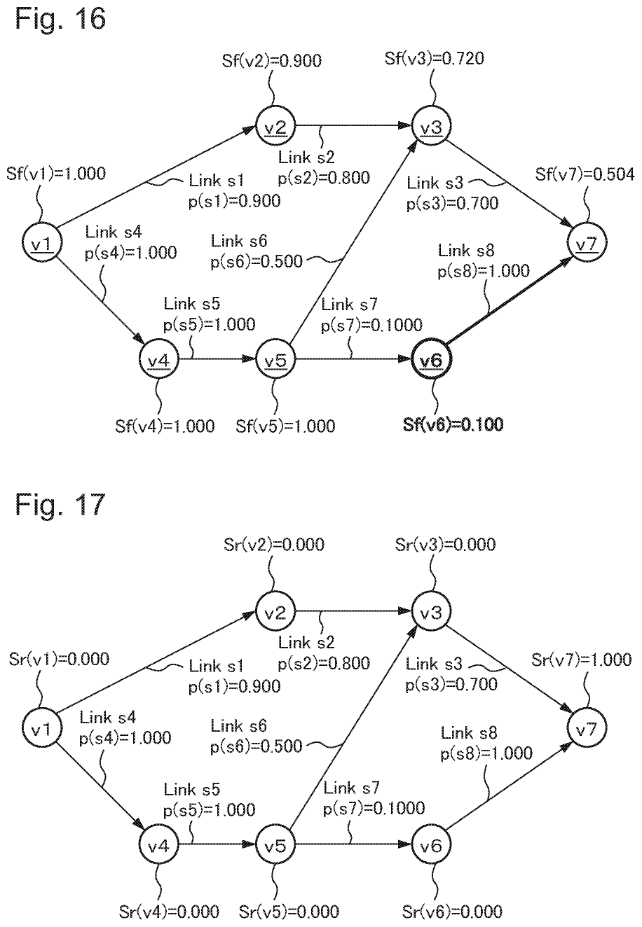

FIG. 16 is a diagram illustrating a next state of FIG. 15. A score in the case of passing through link s8 from node v6 is “0.100”, and is lower than current score Sf(v7) (=0.504) of node v7. Thus, the probability calculation unit 210 does not update score Sf(v7) of node v7. Then, the probability calculation unit 210 sets node v6 as processed.

In FIG. 16, there is no unprocessed node. Thus, the probability calculation unit 210 ends the processing in a forward direction.

(Calculation in Backward Direction)

The probability calculation unit 210 executes calculation as follows, as calculation of a backward-direction score (a second score). The calculation of a backward-direction score is different in (1) and (3) from the calculation of a forward-direction score (a first score).

(1) The probability calculation unit 210 sets, as initial values, a score of a query node to “1.000” and scores of all other nodes to “0.000”. In addition, the probability calculation unit 210 sets all nodes as unprocessed.
(2) The probability calculation unit 210 repeats the following operations of (3) and (4) until there is no unprocessed node.
(3) The probability calculation unit 210 selects one node having a score of a highest value from among unprocessed nodes. Then, the probability calculation unit 210 sets a score of another node being ahead of all links entering the selected node, to a higher one of the following two values. In other words, the probability calculation unit 210 updates a score when a second value (a score in the case of passing through a link in a backward direction from the selected node) is higher than a first value (a current score).
[First value] A current score of another node
[Second value] (A score of the node)×(a probability of a link from the node to another node)
(4) The probability calculation unit 210 sets the node as processed.

A process of this calculation will be described below with reference to the drawings.

FIG. 17 is a diagram illustrating an initial state of backward-direction scores according to the first example embodiment.

As illustrated in FIG. 17, the probability calculation unit 210 sets a score of node v7 being a query to “1.000” and scores of other nodes to “0.000”. Note that, in the following description, “Sr(⋅)” will be used as a function indicating a second score (a backward-direction score) of a node.

In FIG. 17, a node having a highest score among unprocessed nodes is node v7.

In view of the above, the probability calculation unit 210 selects node v7 (this is a query node), which is a node having a score of a highest value. Then, the probability calculation unit 210 updates scores (Sr(v3) and Sr(v6)) of nodes v3 and v6, which are ahead of links (links s3 and s8) entering node v7, and sets node v7 as processed.

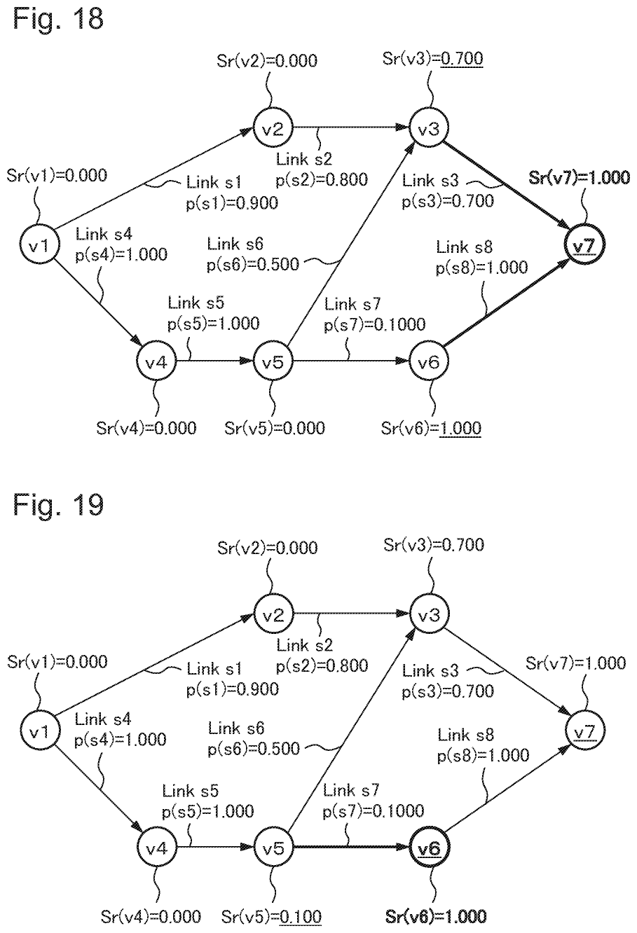

FIG. 18 is a diagram illustrating a next state of FIG. 17.

In FIG. 18, there remain unprocessed nodes. In addition, in FIG. 18, a highest score among the unprocessed nodes is node v6. In view of this, the probability calculation unit 210 selects node v6 as a processing target, and executes similar processing.

FIG. 19 is a diagram illustrating a next state of FIG. 18. As illustrated in FIG. 19, the probability calculation unit 210 updates score Sr(v5) of node v5, which is ahead of link s7 entering node v6, to “0.100”.

In FIG. 19, there remain unprocessed nodes. In addition, in FIG. 19, a highest score among the unprocessed nodes is node v3. In view of this, the probability calculation unit 210 selects node v3 as a processing target, and executes similar processing.

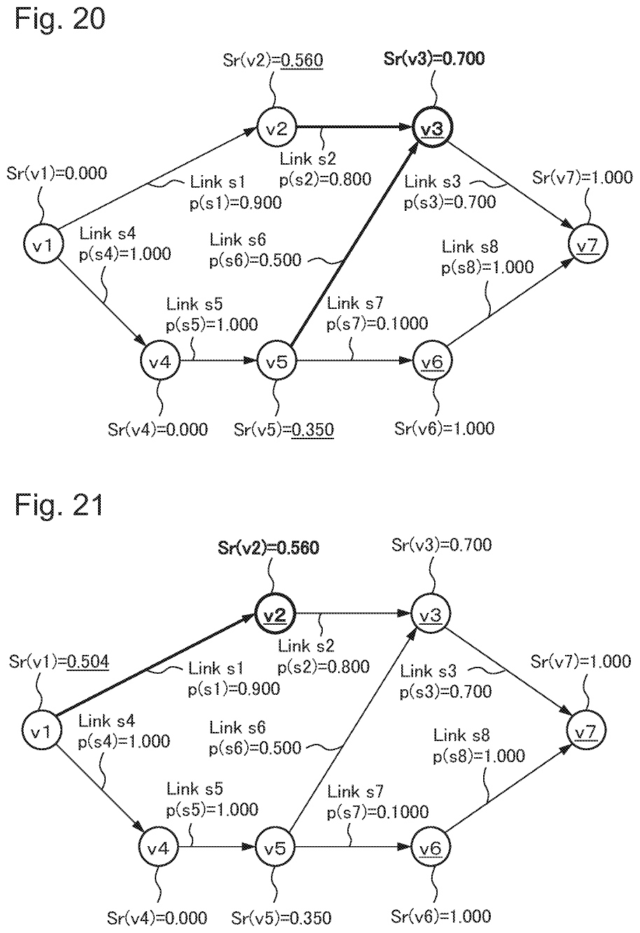

FIG. 20 is a diagram illustrating a next state of FIG. 19. As illustrated in FIG. 20, the probability calculation unit 210 updates scores (Sr(v2) and Sr(v5)) of nodes (nodes v2 and v5), which are ahead of links (links s2 and s6) entering node v3.

In FIG. 20, there remain unprocessed nodes. In addition, in FIG. 20, a highest score among the unprocessed nodes is node v2. In view of this, the probability calculation unit 210 selects node v2 as a processing target, and executes similar processing.

FIG. 21 is a diagram illustrating a next state of FIG. 20. As illustrated in FIG. 21, the probability calculation unit 210 updates score Sr(v1) of node v1, which is ahead of link s1 entering node v2.

In FIG. 21, there remain unprocessed nodes. In addition, in FIG. 21, a highest score among the unprocessed nodes is node v1. In view of this, the probability calculation unit 210 selects node v1 as a processing target, and executes similar processing.

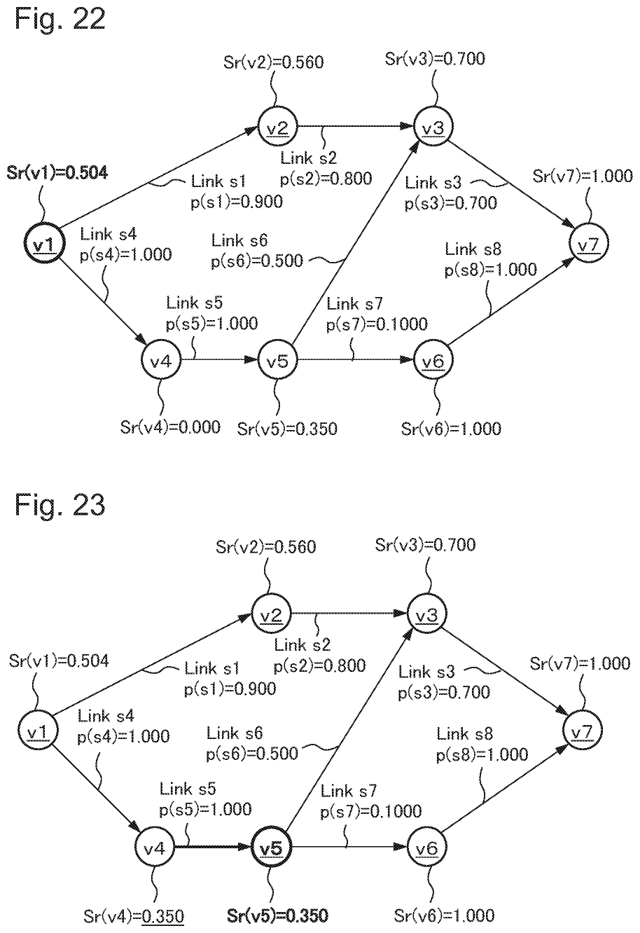

FIG. 22 is a diagram illustrating a next state of FIG. 21. However, node v1 is an observation node. Thus, there is no link entering node v1. In view of this, the probability calculation unit 210 sets node v1 as processed, without calculating a score.

In FIG. 22, there remain unprocessed nodes. In addition, in FIG. 22, a highest score among the unprocessed nodes is node v5. In view of this, the probability calculation unit 210 selects node v5 as a processing target, and executes similar processing.

FIG. 23 is a diagram illustrating a next state of FIG. 22. As illustrated in FIG. 23, the probability calculation unit 210 updates score Sr(v4) of node v4, which is ahead of link s5 entering node v5.

In FIG. 23, there remains an unprocessed node. In addition, in FIG. 23, a highest score among the unprocessed nodes is node v4. In view of this, the probability calculation unit 210 selects node v4 as a processing target, and executes similar processing.

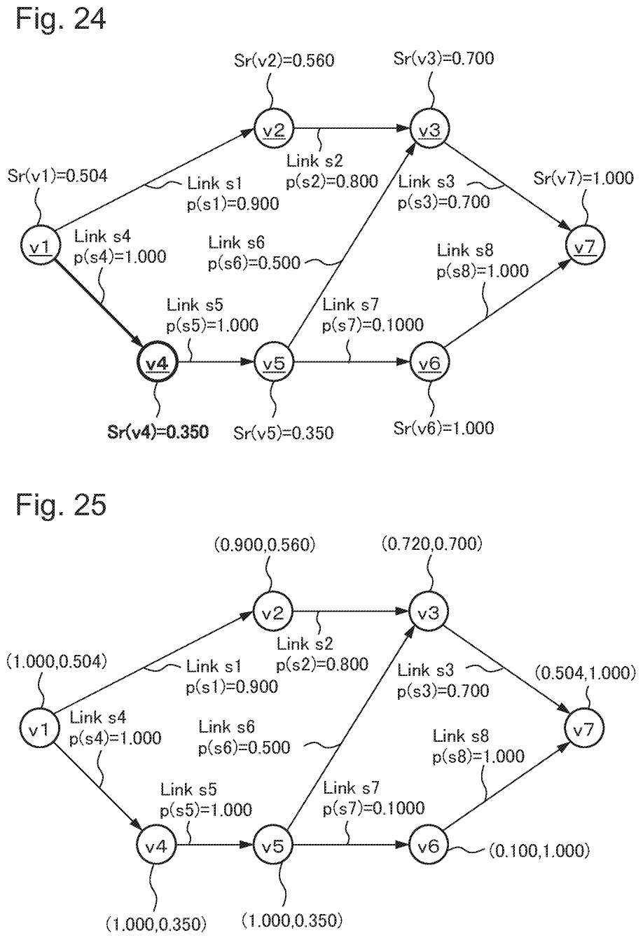

FIG. 24 is a diagram illustrating a next state of FIG. 23. As illustrated in FIG. 24, a score of passing through link s4 from node v4 is lower than the current score Sr(v1) of node v1. In view of this, the probability calculation unit 210 sets node v4 as processed, without updating a score.

In FIG. 24, there is no unprocessed node. Thus, the probability calculation unit 210 ends the calculation in a backward direction.

(Calculation of Evaluation Function)

An operation relevant to an evaluation function in the link extraction unit 220 will be described with reference to the drawings.

FIG. 25 is a diagram illustrating one example of forward-direction scores and backward-direction scores calculated by the probability calculation unit 210. The scores illustrated in FIG. 25 are a result of the above description. In FIG. 25, scores of each node are depicted as (a forward-direction score, a rearward-direction score).

The link extraction unit 220 calculates a value of an evaluation function (an evaluation value) of each link by applying the above scores to the evaluation function in Equation 1.

For example, an evaluation value of link s7 is calculated as follows. A start point of link s7 is node v5. Further, an end point of link s7 is node v6. Then, referring to FIG. 25, values to be included in each term of the evaluation function are as follows.

(1) A forward-direction score from an observation (v1) to the start point (v5) of the link: p(the observation (v1) the start point (v5) of the link)=1.000″
(2) A backward-direction score from the start point (v5) of the link to an query (v7): p(the start point (v5) of the link→the query (v7))=0.350
(3) A forward-direction score from the observation (v1) to the end point (v6) of the link: p(the observation (v1) the end point (v6) of the link)=0.100
(4) A backward-direction score from the end point (v6) of the link to the query (v7): p(the end point (v6) of the link→the query (v7))=1.000 When the above values are applied to the evaluation function, the evaluation value of link s7 becomes as follows.

Evaluation function(s7)=1.000×1.000−max(1.000×0.350,0.100×1.000)=1.000−max(0.350,0.100)=1.000−0.350=0.650

The link extraction unit 220 calculates evaluation values for all links in a similar way.

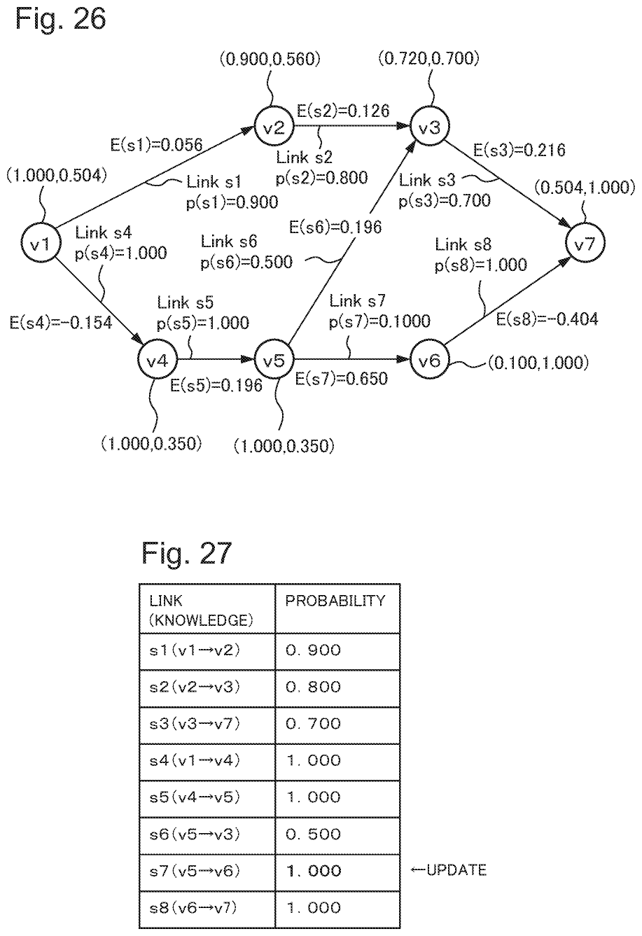

FIG. 26 is a diagram illustrating evaluation values for all links.

Then, the link extraction unit 220 extracts a link having an evaluation value satisfying a predetermined condition. For example, the link extraction unit 220 may extract a link having a highest evaluation value. In this case, the link extraction unit 220 extracts link s7. Alternatively, the link extraction unit 220 may extract a predetermined number of links in descending order of the evaluation values. Alternatively, the link extraction unit 220 may extract a link having an evaluation value higher than a predetermined threshold value.

(Example of Display)

As a reference for understanding the operation of the information processing device 20, an operation will be described by using a display example in the display device 40.

For example, as described above, it is assumed that the link extraction unit 220 extracts link s7 “v5 (Go out with money)→v6 (Hand over money)”. The link output unit 230 outputs information relevant to link s7. It is assumed that this information includes information indicating link s7 and information indicating an inference path that includes link s7 (in the case of now, assumed to include “nodes v1→v4→v5→v6→v7”).

In view of the above, for example, the display device 40 displays “Does knowledge “Go out with money→Hand over money” hold?”. In addition, the display device 40 displays “When this knowledge holds, a path of inference “Receive a phone call from an unknown number→Be told a place→Go out with money→Hand over money→A fraud is established” will be connected with high probability.”.

Then, the update-information acquisition unit 240 acquires, for example, from the input device 50, update-information on the above display. For example, when the update-information acquisition unit 240 acquires a probability of link s7, the inference updating unit 250 updates the probability of link s7.

FIG. 27 is a diagram illustrating one example of the probabilities illustrated in FIG. 8 after updating the probability of link s7. Referring to FIGS. 8 and 27, the probability of link s7 is updated from 0.100 to 1.000.

When a user determines a probability of a link, determination is made generally on the basis of a path of inference including the link, as described above. Thus, it is desirable that the link output unit 230 outputs link information including at least a part of an inference graph such as a path.

### Another Example Embodiment

Note that the description hitherto has been made on a case in which the information processing device 20 operates as a single device. However, the information processing device 20 may update an inference graph used by another device.

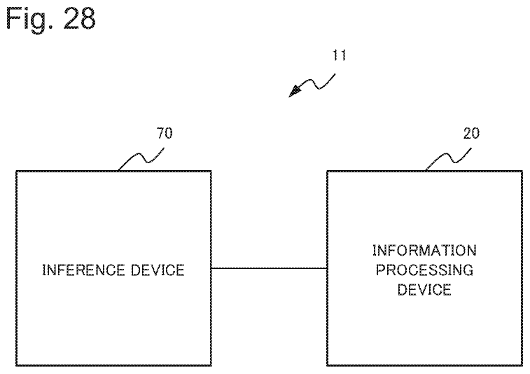

FIG. 28 is a block diagram illustrating one example of a second information processing system 11 including the information processing device 20.

The information processing system 11 includes the information processing device 20 and an inference device 70.

The inference device 70 executes predetermined inference by using an inference graph. For example, the inference device 70 acquires information from a database that stores an event relevant to a crime, and generates an inference graph on the basis of the acquired information. One example of information acquired in this case is the information illustrated in FIGS. 7 and 8.

Then, the inference device 70 infers a process from an observation to a query by using the inference graph.

The information processing device 20 acquires an inference graph (including an observation and a query) from the inference device 70. Then, the information processing device 20 updates the inference graph on the basis of an operation similar to the description hitherto. Then, the information processing device 20 transmits the updated inference graph to the inference device 70.

The inference device 70 infers by using the received updated inference graph. As already described, the information processing device 20 updates a probability of a link to a more appropriate value than before updating. Thus, the inference device 70 is able to achieve more appropriate inference.

As described above, the information processing device 20 can exhibit an advantageous effect of enhancing an inference operation in the inference device 70 being an external device.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

10 Information processing system
11 Information processing system
20 Information processing device
30 Storage device
40 Display device
50 Input device
60 Information processing device
70 Inference device
210 Probability calculation unit
220 Link extraction unit
230 Link output unit
240 Update-information acquisition unit
250 Inference updating unit
610 CPU
620 ROM
630 RAM
640 Internal storage device
650 IOC
660 Input Equipment
670 Display Equipment
680 NIC
700 Storage medium

What is claimed is:

1. An information processing device comprising:
a memory; and
at least one processor coupled to the memory,
the processor performing operations, the operations comprising:
calculating, in a graph including a node and a link indicating a connection relationship between the nodes, a second probability of the node to be calculated, based on a first probability set for the link;
extracting the link, when the second probabilities of the nodes being both ends of the link satisfies a predetermined condition;
outputting first information relevant to the extracted link and the graph;
acquiring second information relevant to the first information; and
updating the first probability of the link in the graph, based on the second information.

2. The information processing device according to claim 1, wherein the operations further comprises
outputting,
as the first information,
information indicating the link, a probability of the link, information indicating the graph, and information indicating an observation node and a query node in the graph including the link.

3. The information processing device according to claim 2, wherein the operations further comprises
calculating,
as the second probabilities, a third probability of a path from the observation node to the query node along a forward direction being a direction from the observation node toward the query node in the graph, and a fourth probability of a path from the node to the query node along a backward direction being a direction from the query node toward the observation node in the graph, and
determining,
by using the third probability and the fourth probability of the nodes at both ends of the link, whether or not the predetermined condition is satisfied.

4. The information processing device according to claim 1, wherein the operations further comprises
re-calculating the second probability by using the graph in which the first probability is updated,
extracting the link, based on the re-calculated second probabilities,
re-outputting the first information relevant to the re-extracted link,
re-acquiring the second information relevant to the re-output first information, and
re-updating the first probability in the graph, based on the re-acquired second information.

5. An information processing method comprising:
calculating, in a graph including a node and a link indicating a connection relationship between the nodes, a second probability of the node to be calculated, based on a first probability set for the link;
extracting the link, when the second probabilities of the nodes being both ends of the link satisfies a predetermined condition;
outputting first information relevant to the extracted link and the graph;
acquiring second information relevant to the first information; and
updating the first probability of the link in the graph, based on the second information.

6. A non-transitory computer-readable recording medium embodying a program, the program causing a computer to perform a method, the method comprising:
calculating, in a graph including a node and a link indicating a connection relationship between the nodes, a second probability of the node to be calculated, based on a first probability set for the link;
extracting the link, when the second probabilities of the nodes being both ends of the link satisfies a predetermined condition;
outputting first information relevant to the extracted link and the graph;
acquiring second information relevant to the first information; and
updating the first probability of the link in the graph, based on the second information.

7-8. (canceled)
